(19) United States
(12) Patent Application Publication
(10) Pub. No.: US 2025/0253579 A1
(43) Pub. Date: Aug. 7, 2025

(54) BOARD-TO-BOARD CONNECTOR ASSEMBLY

(71) Applicant: ADVANCED-CONNECTEK INC., New Taipei City (TW)

(72) Inventors: Jia Chen, New Taipei City (TW); Xu-Dong Xiao, New Taipei City (TW); Wen-Lan Zhang, New Taipei City (TW)

(21) Appl. No.: 19/041,508

(22) Filed: Jan. 30, 2025

Related U.S. Application Data
(60) Provisional application No. 63/549,593, filed on Feb. 5, 2024.

(30) Foreign Application Priority Data
Dec. 25, 2024 (TW) 113214257

(51) Int. Cl. H01R 13/629; H01R 12/70; H01R 12/71; H01R 13/24; H01R 13/502

(52) U.S. Cl. CPC H01R 13/629; H01R 12/707; H01R 12/712; H01R 13/2492; H01R 13/502

(57) ABSTRACT

A board-to-board receptacle connector includes a receptacle connector and a plug connector adapted to be mated with the receptacle connector. The receptacle connector includes a mating base and receptacle terminals held in the mating base. Each receptacle terminal has a mating portion and two clamping arms. The mating portion of each receptacle terminal corresponds to a corresponding terminal groove of the mating base, and the two clamping arms of each receptacle terminal oppositely extend from two sides of the mating portion. The plug connector includes a fixed base and plug terminals respectively arranged the fixed base, each plug terminal includes a connection portion protruding from one of two surfaces of the fixed base, and the connection portion of each plug terminal is adapted to contact an inner side of the clamping arm of the corresponding receptacle terminal.

### CROSS-REFERENCE TO RELATED APPLICATIONS

This application claims the benefit of U.S. provisional application Ser. No. 63/549,593, filed on Feb. 5, 2024 and claims the priority of patent application No. 113214257 filed in Taiwan, R.O.C. on Dec. 25, 2024, the entire contents of which are hereby incorporated by reference.

### FIELD OF THE INVENTION

The instant disclosure relates to a connector assembly, and more particular to a board-to-board connector assembly.

### BACKGROUND

The connector for the connection between boards (e.g., circuit boards) belongs to a board-to-board (also abbreviated as BTB) connector assembly. As known to the inventor, the BTB connector assembly includes a plug connector and a receptacle connector corresponding the plug connector. A plurality of male terminals is arranged on the plug connector, and a plurality of female terminals is arranged on the receptacle connector. When the plug connector is mated with the receptacle connector, the male terminals are mated with the female terminals, so that the signal transmission between the two printed circuit boards on which the plug connector and the receptacle connector are respectively soldered can be achieved. However, when the two printed circuit boards are shaken, the two printed circuit boards may be detached from the plug connector and the receptacle connector easily.

### SUMMARY OF THE INVENTION

In view of these, according to some embodiments, a board-to-board receptacle connector comprising a receptacle connector and a plug connector is provided. The receptacle connector comprises a mating base and a plurality of receptacle terminals held in the mating base. The mating base has a plurality of terminal grooves, and each of the receptacle terminals has a mating portion and two clamping arms. The mating portion of each of the receptacle terminals corresponds to a corresponding one of the terminal grooves of the mating base, and the two clamping arms of each of the receptacle terminals oppositely extend from two sides of the mating portion. The plug connector comprises a fixed base adapted to be mated with the mating base. The fixed base has a plurality of terminal grooves. The plug connector comprises a plurality of plug terminals respectively arranged in the terminal grooves of the fixed base, each of the plug terminals comprises a connection portion protruding from one of two surfaces of the fixed base, and the connection portion of each of the plug terminals is adapted to contact an inner side of the clamping arm of a corresponding one of the receptacle terminals.

In some embodiments, the receptacle connector has a guiding groove at each of two sides of the mating base, the plug connector comprises a guiding post protruding from each of two sides of the fixed base, and each of the guiding posts is adapted to correspond to a corresponding one of the guiding grooves.

In some embodiments, each of the guiding posts comprises a plurality of guiding inclination surfaces, and for each of the guiding posts, the guiding inclination surfaces are arranged at one end of the guiding post away from the fixed base.

In some embodiments, the receptacle connector comprises a plurality of first recessed portions, a plurality of second recessed portions, and a plurality of third recessed portions. Each of the first recessed portions, each of the second recessed portions, and each of the third recessed portions are at an inner wall of a corresponding one of the terminal grooves and adjacent to each other.

In some embodiments, the mating portion of each of the receptacle terminals comprises a first plate, a second plate, and a third plate, and the second plate and the third plate are respectively at two sides of the first plate. The clamping arms extend outward from side ends of the second plate and the third plate. For each of the receptacle terminals and a corresponding one of the terminal grooves, the first plate corresponds to the first recessed portion, the second plate corresponds to the second recessed portion, and the third plate corresponds to the third recessed portion.

According to some embodiments, for each of the receptacle terminals, the first plate and the second plate are perpendicular to each other, the first plate and the third plate are perpendicular to each other, and opposite inner sides of the first plate, the second plate, and the third plate form an insertion channel.

In some embodiments, the mating portion of each of the receptacle terminals comprises a blocking plate outwards extending from a side end of the first plate, and for each of the receptacle terminals, the blocking plate is at a side portion of each of the clamping arms.

In some embodiments, the receptacle connector comprises a plurality of first fixation members, and the first fixation members are assembled on the two sides of the mating base.

In some embodiments, each of the plug terminals comprises a soldering portion outwards extending from the connection portion and exposed from the other surface of the fixed base, the connection portion and the soldering portion are substantially perpendicular to each other, and an extension direction of the soldering portion and the other surface of the fixed base are at a same horizontal plane.

In some embodiments, the plug connector comprises a plurality of second fixation members, and the second fixation members are assembled on the two sides of the fixed base.

Another embodiment of the instant disclosure provides a board-to-board receptacle connector. The board-to-board receptacle connector comprises a mating base and a plurality of receptacle terminals held in the mating base. The mating base has a plurality of terminal grooves. Each of the receptacle terminals has a mating portion and two clamping arms. The mating portion of each of the receptacle terminals corresponds to a corresponding one of the terminal grooves of the mating base, and the two clamping arms of each of the receptacle terminals oppositely extend from two sides of the mating portion.

In some embodiments, a board-to-board plug connector is mated with the board-to-board receptacle connector and comprises a fixed base adapted to be mated with the mating base. The fixed base has a plurality of terminal grooves. The plug connector comprises a plurality of plug terminals respectively arranged in the terminal grooves of the fixed base. Each of the plug terminals comprises a connection portion protruding from one of two surfaces of the fixed base, and the connection portion of each of the plug terminals is adapted to contact an inner side of the clamping arm of a corresponding one of the receptacle terminals.

In some embodiments, the receptacle connector has a guiding groove at each of two sides of the mating base, the plug connector comprises a guiding post protruding from each of two sides of the fixed base, and each of the guiding posts is adapted to correspond to a corresponding one of the guiding grooves.

In some embodiments, each of the guiding posts comprises a plurality of guiding inclination surfaces, and for each of the guiding posts, the guiding inclination surfaces are arranged at one end of the guiding post away from the fixed base.

In some embodiments, the receptacle connector comprises a plurality of first recessed portions, a plurality of second recessed portions, and a plurality of third recessed portions. Each of the first recessed portions, each of the second recessed portions, and each of the third recessed portions are at an inner wall of a corresponding one of the terminal grooves and adjacent to each other.

In some embodiments, the mating portion of each of the receptacle terminals comprises a first plate, a second plate, and a third plate, and the second plate and the third plate are respectively at two sides of the first plate. The clamping arms extend outwards from side ends of the second plate and the third plate. For each of the receptacle terminals and a corresponding one of the terminal grooves, the first plate corresponds to the first recessed portion, the second plate corresponds to the second recessed portion, and the third plate corresponds to the third recessed portion.

In some embodiments, for each of the receptacle terminals, the first plate and the second plate are perpendicular to each other, the first plate and the third plate are perpendicular to each other, and an inner side of the first plate, the second plate, and the third plate forms an insertion channel.

In some embodiments, the mating portion of each of the receptacle terminals comprises a blocking plate outwards extending from a side end of the first plate, and for each of the receptacle terminals, the blocking plate is at a side portion of each of the clamping arms.

In some embodiments, the receptacle connector comprises a plurality of first fixation members, and the first fixation members are assembled on the two sides of the mating base.

In some embodiments, the plug connector comprises a plurality of second fixation members, the second fixation members are assembled on the two sides of the fixed base, and each of the plug terminals comprises a soldering portion outwards extending from the connection portion and exposed from the other surface of the fixed base. The connection portion and the soldering portion are substantially perpendicular to each other, and an extension direction of the soldering portion and the other surface of the fixed base are at a same horizontal plane.

According to some embodiment, the mating portion of each of the receptacle terminals corresponds to the corresponding one of the terminal grooves. Therefore, when the receptacle terminals are assembled in the terminal grooves, the mating portions can be stably positioned in the terminal grooves. Moreover, according to some embodiments, the mating portion and the clamping arms of each of the receptacle terminals correspond to the connection portion of the corresponding one of the plug terminals. Therefore, the receptacle connector and the plug connector can be mated with each other stably.

Detailed description of the characteristics and the advantages of the instant disclosure are shown in the following embodiments. The technical content and the implementation of the instant disclosure should be readily apparent to any person skilled in the art from the detailed description, and the purposes and the advantages of the instant disclosure should be readily understood by any person skilled in the art with reference to content, claims, and drawings in the instant disclosure.

### BRIEF DESCRIPTION OF THE DRAWINGS

The instant disclosure will become more fully understood from the detailed description given herein below for illustration only, and thus not limitative of the instant disclosure, wherein:

FIG. 1 illustrates a front perspective view of a receptacle connector and a plug connector according to some embodiments of the instant disclosure;

FIG. 2 illustrates a rear perspective view of the receptacle connector and the plug connector according to some embodiments of the instant disclosure;

FIG. 3 illustrates a front exploded view of the receptacle connector according to some embodiments of the instant disclosure;

FIG. 4 illustrates a partial perspective view of the receptacle connector according to some embodiments of the instant disclosure;

FIG. 5 illustrates a rear exploded view of the receptacle connector according to some embodiments of the instant disclosure;

FIG. 6 illustrates a front exploded view of the plug connector according to some embodiments of the instant disclosure;

FIG. 7 illustrates a rear exploded view of the plug connector according to some embodiments of the instant disclosure;

FIG. 8 illustrates a top view of the receptacle connector and the plug connector according to some embodiments of the instant disclosure;

FIG. 9 illustrates a cross-sectional view along the line 9-9 shown in FIG. 8;

FIG. 10 illustrates a cross-sectional view of the receptacle connector and the plug connector in a perspective view of FIG. 9, where the receptacle connector and the plug connector are mated with each other;

FIG. 11 illustrates a cross-sectional view along the line 11-11 shown in FIG. 8;

FIG. 12 illustrates a cross-sectional view of the receptacle connector and the plug connector in a perspective view of FIG. 11, where the receptacle connector and the plug connector are mated with each other;

FIG. 13 illustrates a perspective view of a receptacle terminal and a plug terminal according to some embodiments of the instant disclosure, where the receptacle terminal and the plug terminal are to be mated with each other; and

FIG. 14 illustrates a perspective view of the receptacle terminal and the plug terminal according to some embodiments of the instant disclosure, where the receptacle terminal and the plug terminal are mated with each other.

### DETAILED DESCRIPTION

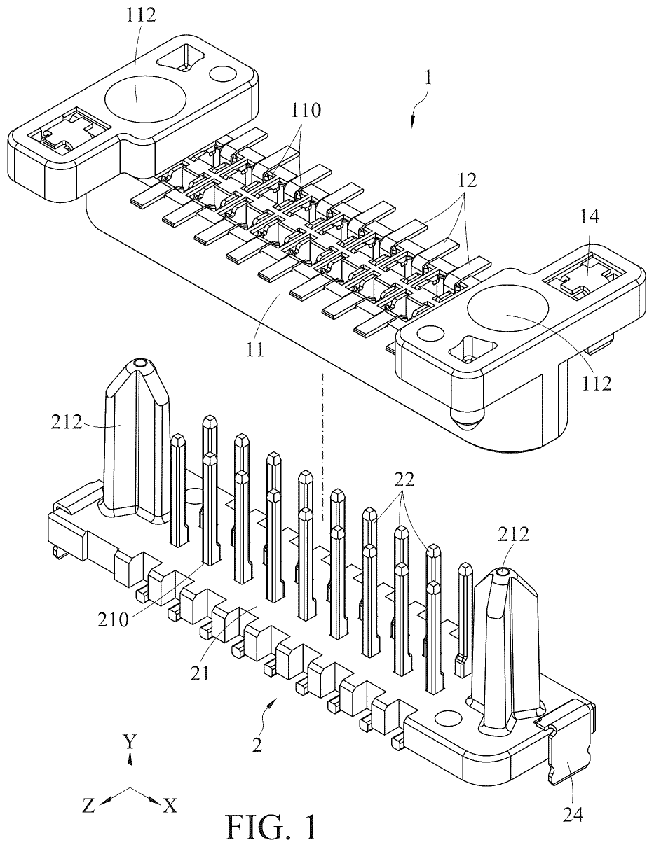

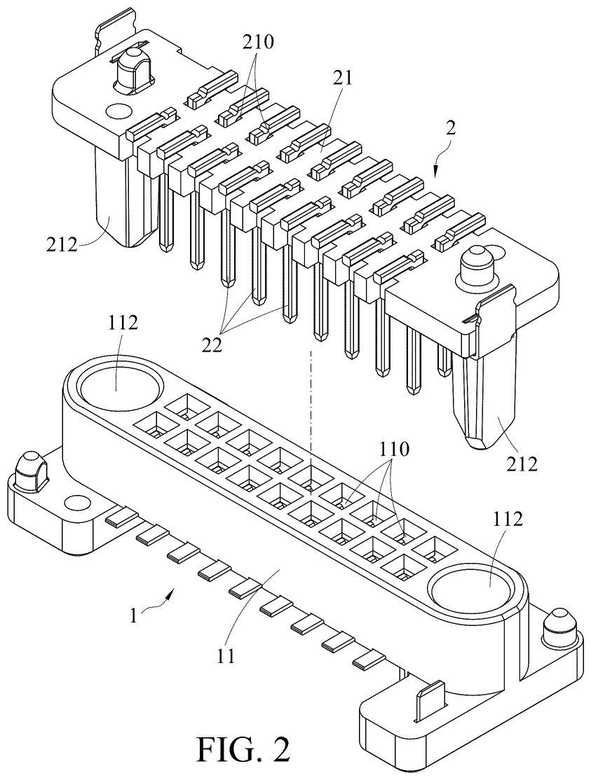

Please refer to FIG. 1 and FIG. 2. FIG. 1 illustrates a front perspective view of a receptacle connector 1 and a plug connector 2 according to some embodiments of the instant disclosure. FIG. 2 illustrates a rear perspective view of the receptacle connector 1 and the plug connector 2 according to some embodiments of the instant disclosure. A board-to-board connector assembly comprises a receptacle connector 1 (also abbreviated as receptacle) and a plug connector 2 (also abbreviated as plug). The receptacle connector 1 is assembled on a circuit board, and the plug connector 2 is assembled on another circuit board. The board-to-board connector assembly is adapted to be utilized as board-to-board connectors. The receptacle connector 1 comprises a mating base 11 and a plurality of receptacle terminals 12. The plug connector 2 comprises a fixed base 21 and a plurality of plug terminals 22.

The receptacle connector 1 comprises a mating base 11 and a plurality of receptacle terminals 12 held in the mating base 11, and the mating base 11 has a plurality of terminal grooves 110. Each of the receptacle terminals 12 has a mating portion 121 and two clamping arms 122, the mating portion 121 of each of the receptacle terminals 12 corresponds to a corresponding one of the terminal grooves 110 of the mating base 11, and the two clamping arms 122 of each of the receptacle terminals 12 oppositely extend from two sides of the mating portion 121. The plug connector 2 comprises a fixed base 21, and the fixed base 21 has a plurality of terminal grooves 210. The plug connector 2 comprises a plurality of plug terminals 22 respectively held in the terminal grooves 210 of the fixed base 21. Each of the plug terminals 22 comprises a connection portion 221 protruding from one of two surfaces of the fixed base 21. The number of the receptacle terminals 12 is eighteen, and the number of the plug terminals 22 is eighteen.

When the plug connector 2 is mated with the receptacle connector 1, the fixed base 21 of the plug connector 2 is mated with the mating base 11 of the receptacle connector 1, so that the connection portion 221 of each of the plug terminals 22 contacts an inner side of the clamping arm 122 of a corresponding one of the receptacle terminals 12.

Please refer to FIG. 1 and FIG. 2. The mating base 11 of the receptacle connector 1 is an elongated rectangular plastic body, the long side of the mating base 11 extends along a first axis X direction, the short side of the mating base 11 extends along a third axis Z direction, and the height of the mating base 11 extends along a second axis Y direction; viewing from the first axis X direction, the mating base 11 is formed as a T-shaped structure. The fixed base 21 of the plug connector 2 is an elongated rectangular plastic body, the long side of the fixed base 21 extends along the first axis X direction, the short side of the fixed base 21 extends along the third axis Z direction, and the height of the fixed base 21 extends along the second axis Y direction; viewing from the first axis X direction, the fixed base is formed as an inverse T-shaped structure.

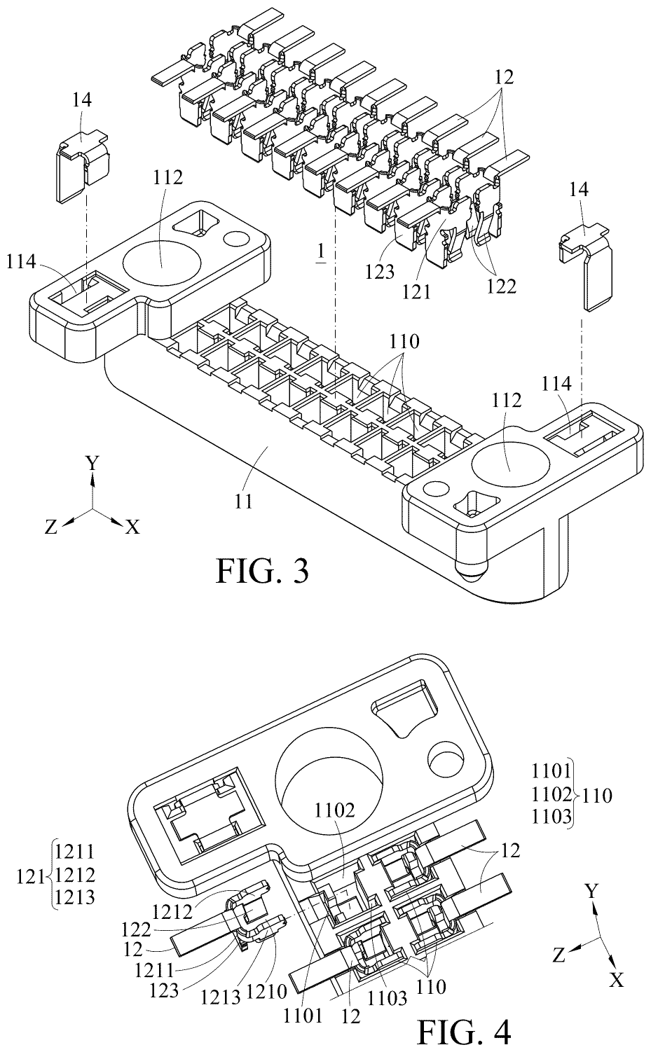

Please refer to FIG. 3 and FIG. 4. FIG. 3 illustrates a front exploded view of the receptacle connector 1 according to some embodiments of the instant disclosure. FIG. 4 illustrates a partial perspective view of the receptacle connector 1 according to some embodiments of the instant disclosure. In some embodiments, the receptacle connector 1 comprises a plurality of first recessed portions 1101, a plurality of second recessed portions 1102, and a plurality of third recessed portions 1103. Each of the first recessed portions 1101, each of the second recessed portions 1102, and each of the third recessed portions 1103 are at an inner wall of a corresponding one of the terminal grooves 110 and adjacent to each other. Each of the terminal grooves 110 is a through hole and defined through the mating base 11 between one of the two surfaces of the mating base 11 and the other surface of the mating base 11. The first recessed portion 1101 is arranged on an inner surface of the terminal groove 110 along the first axis X direction, the second recessed portion 1102 is arranged on an inner surface of the terminal groove 110 along the third axis Z direction, and the third recessed portion 1103 is arranged on the inner surface of the terminal groove 110 along the first axis X direction. The second recessed portion 1102 and the third recessed portion 1103 are parallel to each other, and the first recessed portion 1101 is between the second recessed portion 1102 and the third recessed portion 1103.

Please refer to FIG. 3 and FIG. 4. In some embodiments, the mating portion 121 of each of the receptacle terminals 12 comprises a first plate 1211, a second plate 1212, and a third plate 1213, and the second plate 1212 and the third plate 1213 are respectively at two sides of the first plate 1211. The first plate 1211 is arranged along the first axis X direction, the second plate 1212 is arranged along the third axis Z direction, and the third plate 1213 is arranged along the first axis X direction. The second plate 1212 and the third plate 1213 are parallel to each other, and the first plate 1211 is between the second plate 1212 and the third plate 1213. Viewing from the second axis Y direction, the first plate 1211, the second plate 1212, and the third plate 1213 are together formed as a U-shaped structure. Moreover, the first plate 1211 and the second plate 1212 are substantially perpendicular to each other, the first plate 1211 and the third plate 1213 are substantially perpendicular to each other. Opposite inner sides of the first plate 1211, the second plate 1212, and the third plate 1213 form an insertion channel 1210, and the insertion channel 1210 is in communication with the terminal groove 110.

Please refer to FIG. 3 and FIG. 4. In some embodiments, the clamping arms 122 of each of the receptacle terminals 12 outwards extend from side ends of the second plate 1212 and the third plate 1213. The clamping arms 122 are arranged obliquely, and an end portion of each of the clamping arms 122 is an arced structure. When each of the receptacle terminals 12 is assembled in a corresponding one of the terminal grooves 110, the first plate 1211 corresponds to the first recessed portion 1101 and is positioned in the first recessed portion 1101, the second plate 1212 corresponds to the second recessed portion 1102 and is positioned in the second recessed portion 1102, and the third plate 1213 corresponds to the third recessed portion 1103 and is positioned in the third recessed portion 1103.

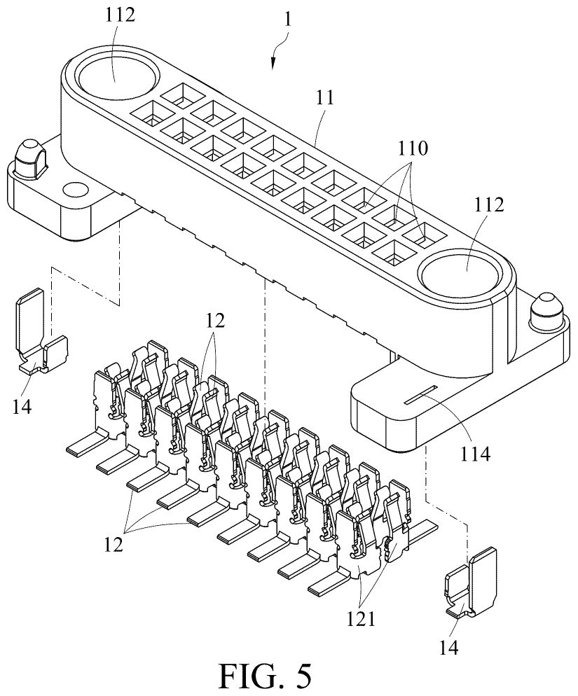

Please refer to FIG. 3 and FIG. 5. FIG. 5 illustrates a rear exploded view of the receptacle connector 1 according to some embodiments of the instant disclosure. In some embodiments, the receptacle connector 1 comprises a plurality of first fixation members 14. Along the third axis Z direction shown in FIG. 3, each of the first fixation members 14 is formed as an inverse U-shaped structure. After the first fixation members 14 are respectively aimed at first engaging grooves 114 at two sides of the mating base 11, the first fixation members 14 can be assembled in the first engaging grooves 114 at the two sides of the mating base 11.

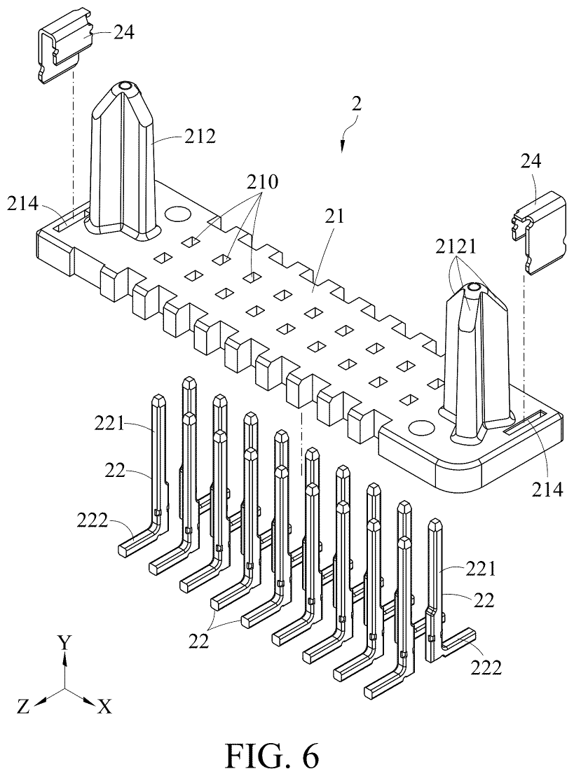

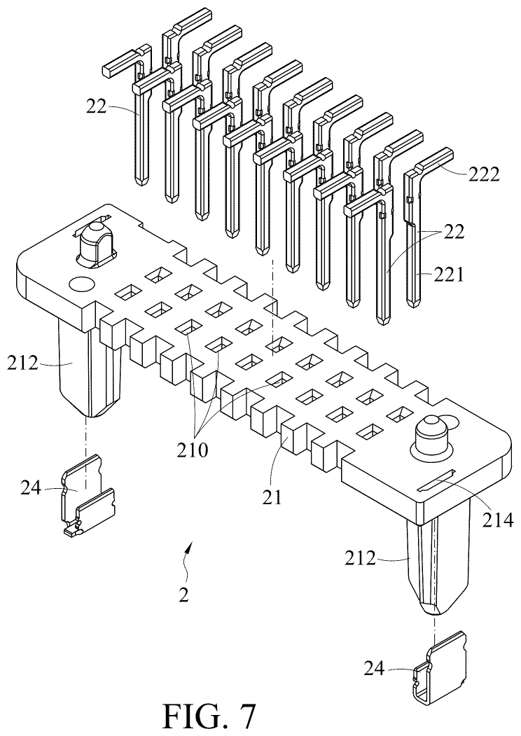

Please refer to FIG. 6 and FIG. 7. FIG. 6 illustrates a front exploded view of the plug connector 2 according to some embodiments of the instant disclosure. FIG. 7 illustrates a rear exploded view of the plug connector 2 according to some embodiments of the instant disclosure. In some embodiments, the plug connector 2 comprises a plurality of second fixation members 24. Along the third axis Z direction shown in FIG. 6, each of the second fixation members 24 is formed as an inverse U-shaped structure. After the second fixation members 24 are respectively aimed at second engaging grooves 214 at two sides of the fixed base 21, the second fixation members 24 can be assembled in the second engaging grooves 214 at the two sides of the fixed base 21.

Please refer to FIG. 6 and FIG. 7. In some embodiments, each of the plug terminals 22 comprises a soldering portion 222 outwards extending from the connection portion 221 and exposed from the other surface of the fixed base 21 (the surface of the fixed base 21 away from the guiding post 212), and the connection portion 221 and the soldering portion 222 are substantially perpendicular to each other. Viewing from the first axis X direction, the connection portion 221 and the soldering portion 222 are formed as an L-shaped structure. When each of the plug terminals 22 is assembled in the corresponding one of the terminal grooves 210 of the fixed base 21, the soldering portion 222 of each of the plug terminals 22 is aligned with the other surface of the fixed base 21, so that an extension direction of the soldering portion 222 and the other surface of the fixed base 21 are at a same horizontal plane (as shown in FIG. 2).

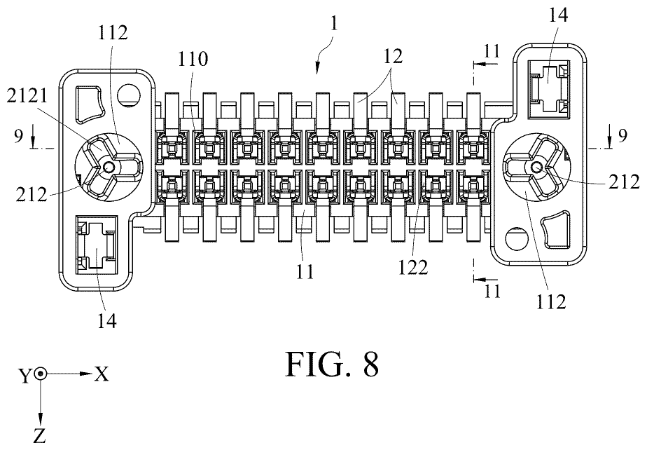

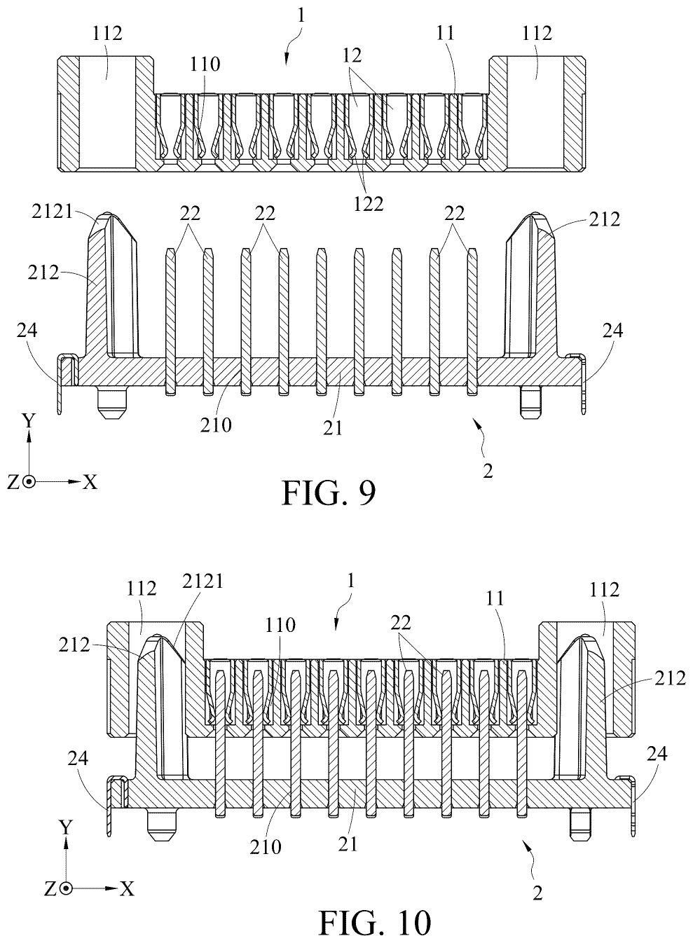

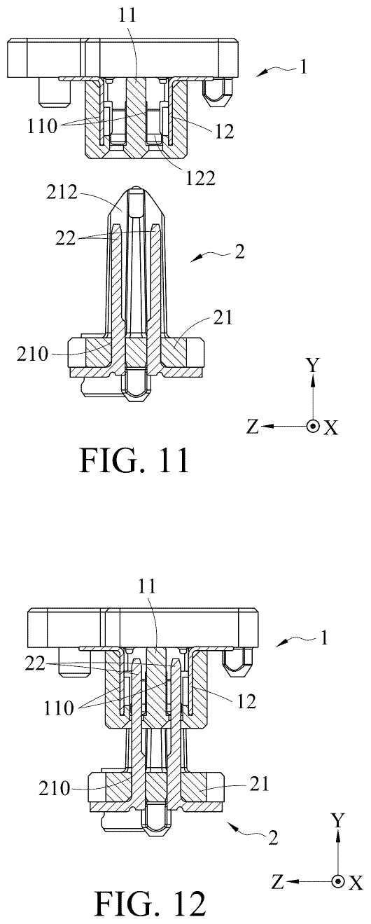

Please refer to FIG. 8 to FIG. 12. FIG. 8 illustrates a top view of the receptacle connector 1 and the plug connector 2 according to some embodiments of the instant disclosure. FIG. 9 illustrates a cross-sectional view along the line 9-9 shown in FIG. 8. FIG. 10 illustrates a cross-sectional view of the receptacle connector 1 and the plug connector 2 in a perspective view of FIG. 9, where the receptacle connector 1 and the plug connector 2 are mated with each other. FIG. 11 illustrates a cross-sectional view along the line 11-11 shown in FIG. 8. FIG. 12 illustrates a cross-sectional view of the receptacle connector 1 and the plug connector 2 in a perspective view of FIG. 11, where the receptacle connector 1 and the plug connector 2 are mated with each other. In some embodiments, the receptacle connector 1 has a guiding groove 112 at each of the two sides of the mating base 11. The guiding groove 112 is a through hole and defined through the mating base 11 between one of the two surfaces of the mating base 11 and the other surface of the mating base 11. The plug connector 2 comprises a guiding post 212 protruding from each of the two sides of the fixed base 21. From the second axis Y direction, the guiding post 212 is formed as a Y-shape structure, and the guiding post 212 is a cone structure. A top portion of the guiding post 212 has a plurality of guiding inclination surfaces 2121, and the guiding inclination surfaces 2121 are arranged at one end of the guiding post 212 away from the fixed base 21. The height of the top portion of the guiding post 212 is greater than the height of the connection portion 221 of the plug terminal 22. When each of the guiding posts 212 is inserted into a corresponding one of the guiding grooves 112, the guiding post 12 corresponds to the guiding groove 112. Therefore, even the plug connector 2 is obliquely inserted into the receptacle connector 1, the plug connector 2 can be properly mated with the receptacle connector 1 through the guiding between the guiding post 12 and the guiding groove 112.

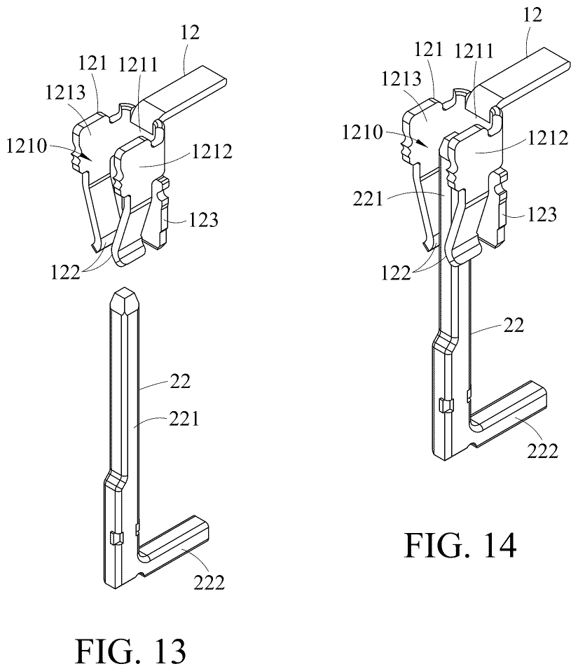

Please refer to FIG. 13 and FIG. 14. FIG. 13 illustrates a perspective view of a receptacle terminal 12 and a plug terminal 22 according to some embodiments of the instant disclosure, where the receptacle terminal 12 and the plug terminal 22 are to be mated with each other. FIG. 14 illustrates a perspective view of the receptacle terminal 12 and the plug terminal 22 according to some embodiments of the instant disclosure, where the receptacle terminal 12 and the plug terminal 22 are mated with each other. In some embodiments, the mating portion 121 of each of the receptacle terminals 12 comprises a blocking plate 123 outwards protruding from a side end of the first plate 1211, and the blocking plate 123 is at a side portion of each of the clamping arms 122. When the connection portion 221 of each of the plug terminals 22 is mated with the mating portion 121 of the corresponding one of the receptacle terminals 12, the connection portion 221 is guided by the arced structure at the end portion of the clamping arm 122, so that the connection portion 221 is inserted into the insertion channel 1210 through an opening between the clamping arm 122 and the blocking plate 123. Next, when the connection portion 221 of the plug terminal 22 reaches to the inserted position, the top portion of the connection portion 221 is completely within the first plate 1211, the second plate 1212, and the third plate 1213. Therefore, because the mating portion 121 and the clamping arms 122 of each of the receptacle terminals 12 correspond to the connection portion 221 of the corresponding one of the plug terminals 22, the receptacle connector 1 and the plug connector 2 can be mated with each other stably.

According to some embodiment, the mating portion of each of the receptacle terminals corresponds to the corresponding one of the terminal grooves. Therefore, when the receptacle terminals are assembled in the terminal grooves, the mating portions can be stably positioned in the terminal grooves. Moreover, according to some embodiments, the mating portion and the clamping arms of each of the receptacle terminals correspond to the connection portion of the corresponding one of the plug terminals. Therefore, the receptacle connector and the plug connector can be mated with each other stably.

While the instant disclosure has been described by the way of example and in terms of the preferred embodiments, it is to be understood that the invention need not be limited to the disclosed embodiments. On the contrary, it is intended to cover various modifications and similar arrangements included within the spirit and scope of the appended claims, the scope of which should be accorded the broadest interpretation so as to encompass all such modifications and similar structures.

What is claimed is:

1. A board-to-board connector assembly comprising:
a receptacle connector comprising a mating base and a plurality of receptacle terminals held in the mating base, wherein the mating base has a plurality of terminal grooves, each of the receptacle terminals has a mating portion and two clamping arms, the mating portion of each of the receptacle terminals correspond to a corresponding one of the terminal grooves of the mating base, and the two clamping arms of each of the receptacle terminals oppositely extend from two sides of the mating portion; and
a plug connector comprising a fixed base adapted to be mated with the mating base, wherein the fixed base has a plurality of terminal grooves, and the plug connector comprises a plurality of plug terminals respectively arranged in the terminal grooves of the fixed base, each of the plug terminals comprises a connection portion protruding from one of two surfaces of the fixed base, and the connection portion of each of the plug terminals is adapted to contact an inner side of the clamping arm of a corresponding one of the receptacle terminals.

2. The board-to-board connector assembly according to claim 1, wherein the receptacle connector has a guiding groove at each of two sides of the mating base, the plug connector comprises a guiding post protruding from each of two sides of the fixed base, and each of the guiding posts is adapted to correspond to a corresponding one of the guiding grooves.

3. The board-to-board connector assembly according to claim 2, wherein each of the guiding posts comprises a plurality of guiding inclination surfaces, and for each of the guiding posts, the guiding inclination surfaces are arranged at one end of the guiding post away from the fixed base.

4. The board-to-board connector assembly according to claim 2, wherein the receptacle connector comprises a plurality of first recessed portions, a plurality of second recessed portions, and a plurality of third recessed portions; each of the first recessed portions, each of the second recessed portions, and each of the third recessed portions are at an inner wall of a corresponding one of the terminal grooves and adjacent to each other.

5. The board-to-board connector assembly according to claim 4, wherein the mating portion of each of the receptacle terminals comprises a first plate, a second plate, and a third plate, and the second plate and the third plate are respectively at two sides of the first plate; the clamping arms extend outwards from side ends of the second plate and the third plate; for each of the receptacle terminals and a corresponding one of the terminal grooves, the first plate corresponds to the first recessed portion, the second plate corresponds to the second recessed portion, and the third plate corresponds to the third recessed portion.

6. The board-to-board connector assembly according to claim 5, wherein for each of the receptacle terminals, the first plate and the second plate are perpendicular to each other, the first plate and the third plate are perpendicular to each other, and an inner side of the first plate, the second plate, and the third plate forms an insertion channel.

7. The board-to-board connector assembly according to claim 5, wherein the mating portion of each of the receptacle terminals comprises a blocking plate outwards extending from a side end of the first plate, and for each of the receptacle terminals, the blocking plate is at a side portion of each of the clamping arms.

8. The board-to-board connector assembly according to claim 5, wherein the receptacle connector comprises a plurality of first fixation members, and the first fixation members are assembled on the two sides of the mating base.

9. The board-to-board connector assembly according to claim 2, wherein each of the plug terminals comprises a soldering portion outwards extending from the connection portion and exposed from the other surface of the fixed base, the connection portion and the soldering portion are substantially perpendicular to each other, and an extension direction of the soldering portion and the other surface of the fixed base are at a same horizontal plane.

10. The board-to-board connector assembly according to claim 9, wherein the plug connector comprises a plurality of second fixation members, and the second fixation members are assembled on the two sides of the fixed base.

11. A board-to-board receptacle connector comprising:
a mating base and a plurality of receptacle terminals held in the mating base, wherein the mating base has a plurality of terminal grooves, each of the receptacle terminals has a mating portion and two clamping arms, the mating portion of each of the receptacle terminals correspond to a corresponding one of the terminal grooves of the mating base, and the two clamping arms of each of the receptacle terminals oppositely extend from two sides of the mating portion.

12. The board-to-board receptacle connector according to claim 11, wherein a board-to-board plug connector is mated with the board-to-board receptacle connector and comprises a fixed base adapted to be mated with the mating base, wherein the fixed base has a plurality of terminal grooves, and the plug connector comprises a plurality of plug terminals respectively arranged in the terminal grooves of the fixed base; each of the plug terminals comprises a connection portion protruding from one of two surfaces of the fixed base, and the connection portion of each of the plug terminals is adapted to contact an inner side of the clamping arm of a corresponding one of the receptacle terminals.

13. The board-to-board receptacle connector according to claim 12, wherein the receptacle connector has a guiding groove at each of two sides of the mating base, the plug connector comprises a guiding post protruding from each of two sides of the fixed base, and each of the guiding posts is adapted to correspond to a corresponding one of the guiding grooves.

14. The board-to-board receptacle connector according to claim 13, wherein each of the guiding posts comprises a plurality of guiding inclination surfaces, and for each of the guiding posts, the guiding inclination surfaces are arranged at one end of the guiding post away from the fixed base.

15. The board-to-board receptacle connector according to claim 13, wherein the receptacle connector comprises a plurality of first recessed portions, a plurality of second recessed portions, and a plurality of third recessed portions; each of the first recessed portions, each of the second recessed portions, and each of the third recessed portions are at an inner wall of a corresponding one of the terminal grooves and adjacent to each other.

16. The board-to-board receptacle connector according to claim 15, wherein the mating portion of each of the receptacle terminals comprises a first plate, a second plate, and a third plate, and the second plate and the third plate are respectively at two sides of the first plate; the clamping arms extend outwards from side ends of the second plate and the third plate; for each of the receptacle terminals and a corresponding one of the terminal grooves, the first plate corresponds to the first recessed portion, the second plate corresponds to the second recessed portion, and the third plate corresponds to the third recessed portion.

17. The board-to-board receptacle connector according to claim 16, wherein for each of the receptacle terminals, the first plate and the second plate are perpendicular to each other, the first plate and the third plate are perpendicular to each other, and an inner side of the first plate, the second plate, and the third plate forms an insertion channel.

18. The board-to-board receptacle connector according to claim 16, wherein the mating portion of each of the receptacle terminals comprises a blocking plate outwards extending from a side end of the first plate, and for each of the receptacle terminals, the blocking plate is at a side portion of each of the clamping arms.

19. The board-to-board receptacle connector according to claim 16, wherein the receptacle connector comprises a plurality of first fixation members, and the first fixation members are assembled on the two sides of the mating base.

20. The board-to-board receptacle connector according to claim 13, wherein the plug connector comprises a plurality of second fixation members, the second fixation members are assembled on the two sides of the fixed base, and each of the plug terminals comprises a soldering portion outwards extending from the connection portion and exposed from the other surface of the fixed base; the connection portion and the soldering portion are substantially perpendicular to each other, and an extension direction of the soldering portion and the other surface of the fixed base are at a same horizontal plane.
